(19) United States
(12) Patent Application Publication
(10) Pub. No.: US 2024/0396999 A1
(43) Pub. Date: Nov. 28, 2024

(54) VOICE CALLBACK FEATURE FOR DEVICE WITH MULTIPLE SUBSCRIBER IDENTITY MODULES

(71) Applicant: QUALCOMM Incorporated, San Diego, CA (US)

(72) Inventors: Francis Ming-Meng NGAI, Louisville, CO (US); Qingxin CHEN, San Diego, CA (US); Jun HU, San Diego, CA (US); Ling XIE, Beijing (CN); Mutaz Zuhier Afif SHUKAIR, San Diego, CA (US); Reza SHAHIDI, La Jolla, CA (US)

(21) Appl. No.: 18/696,672

(22) PCT Filed: Dec. 21, 2021
(86) PCT No.: PCT/CN2021/139931

§ 371 Date: Mar. 28, 2024

(51) Int. Cl. H04M 3/54; H04M 3/42; H04W 88/06

(52) U.S. Cl. CPC H04M 3/541; H04M 3/42059; H04W 88/06

(57) ABSTRACT

Various aspects of the present disclosure generally relate to wireless communication. In some aspects, a user equipment (UE) may receive, during an ongoing data session on a first subscriber identity module (SIM), an incoming voice call on a second SIM. The UE may determine, during the ongoing data session on the first SIM, a caller identifier associated with the incoming voice call on the second SIM. The UE may initiate, on the first SIM, a communication to the caller identifier associated with the incoming voice call in concurrency with the ongoing data session. Numerous other aspects are described.

### FIELD OF THE DISCLOSURE

Aspects of the present disclosure generally relate to wireless communication and to techniques and apparatuses associated with a voice callback feature for a device with multiple subscriber identity modules (SIMs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, during an ongoing data session on a first subscriber identity module (SIM), an incoming voice call on a second SIM. The method may include determining, during the ongoing data session on the first SIM, a caller identifier associated with the incoming voice call on the second SIM. The method may include initiating, on the first SIM, a communication to the caller identifier associated with the incoming voice call in concurrency with the ongoing data session.

Some aspects described herein relate to a UE for wireless communication. The UE may include a memory and one or more processors coupled to the memory. The one or more processors may be configured to receive, during an ongoing data session on a first SIM, an incoming voice call on a second SIM. The one or more processors may be configured to determine, during the ongoing data session on the first SIM, a caller identifier associated with the incoming voice call on the second SIM. The one or more processors may be configured to initiate, on the first SIM, a communication to the caller identifier associated with the incoming voice call in concurrency with the ongoing data session.

Some aspects described herein relate to a non-transitory computer-readable medium that stores a set of instructions for wireless communication by a UE. The set of instructions, when executed by one or more processors of the UE, may cause the UE to receive, during an ongoing data session on a first SIM, an incoming voice call on a second SIM. The set of instructions, when executed by one or more processors of the UE, may cause the UE to determine, during the ongoing data session on the first SIM, a caller identifier associated with the incoming voice call on the second SIM. The set of instructions, when executed by one or more processors of the UE, may cause the UE to initiate, on the first SIM, a communication to the caller identifier associated with the incoming voice call in concurrency with the ongoing data session.

Some aspects described herein relate to an apparatus for wireless communication. The apparatus may include means for receiving, during an ongoing data session on a first SIM, an incoming voice call on a second SIM. The apparatus may include means for determining, during the ongoing data session on the first SIM, a caller identifier associated with the incoming voice call on the second SIM. The apparatus may include means for initiating, on the first SIM, a communication to the caller identifier associated with the incoming voice call in concurrency with the ongoing data session.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example radio and baseband architecture in a UE having multiple subscriber identity modules (SIMs), in accordance with the present disclosure.

FIG. 4 is a diagram illustrating an example associated with a voice callback feature for a multi-SIM device, in accordance with the present disclosure.

FIG. 5 is a diagram illustrating an example process associated with a voice callback feature for a multi-SIM device, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

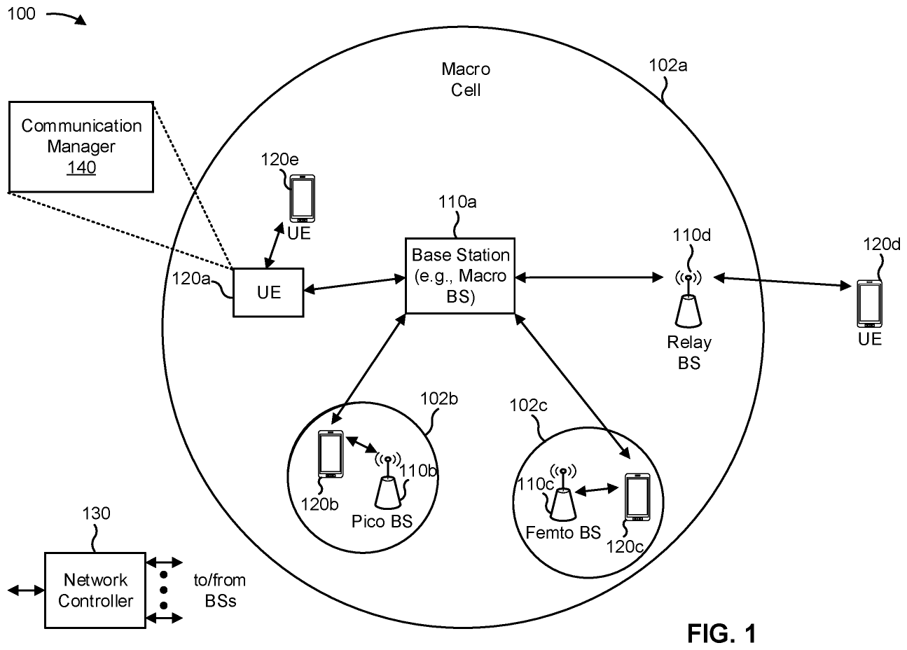

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, during an ongoing data session on a first subscriber identity module (SIM), an incoming voice call on a second SIM; determine, during the ongoing data session on the first SIM, a caller identifier associated with the incoming voice call on the second SIM; and initiate, on the first SIM, a communication to the caller identifier associated with the incoming voice call in concurrency with the ongoing data session. Additionally, or alternatively, the communication manager 140 may perform one or more other operations described herein.

As indicated above, FIG. 1 is provided as an example. Other examples may differ from what is described with regard to FIG. 1.

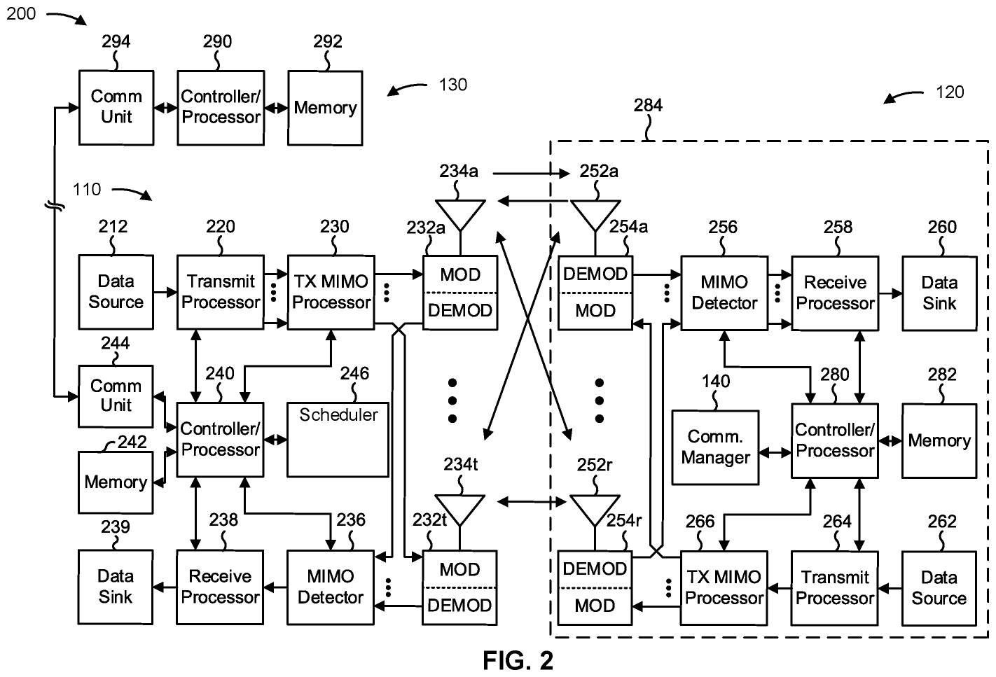

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

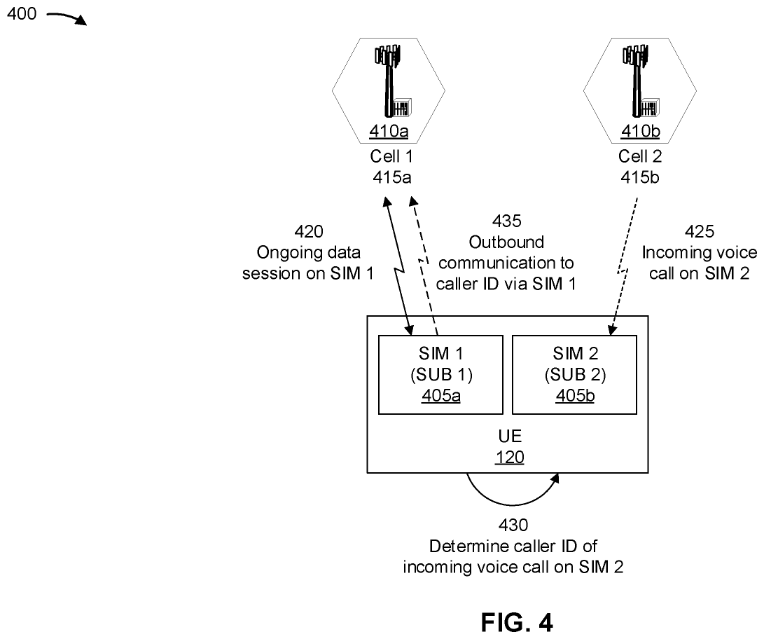

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6).

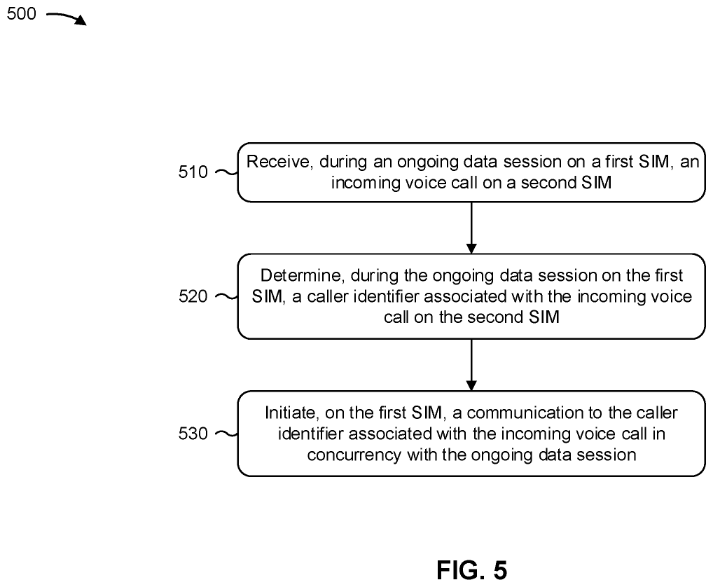

The controller/processor 240 of the base station 110, the controller/processor 280 of the UE 120, and/or any other component(s) of FIG. 2 may perform one or more techniques associated with a voice callback feature for a multi-SIM device, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5 and/or other processes as described herein. In some examples, executing instructions may include running the instructions, converting the instructions, compiling the instructions, and/or interpreting the instructions, among other examples.

In some aspects, the UE 120 includes means for receiving, during an ongoing data session on a first SIM, an incoming voice call on a second SIM; means for determining, during the ongoing data session on the first SIM, a caller identifier associated with the incoming voice call on the second SIM; and/or means for initiating, on the first SIM, a communication to the caller identifier associated with the incoming voice call in concurrency with the ongoing data session. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

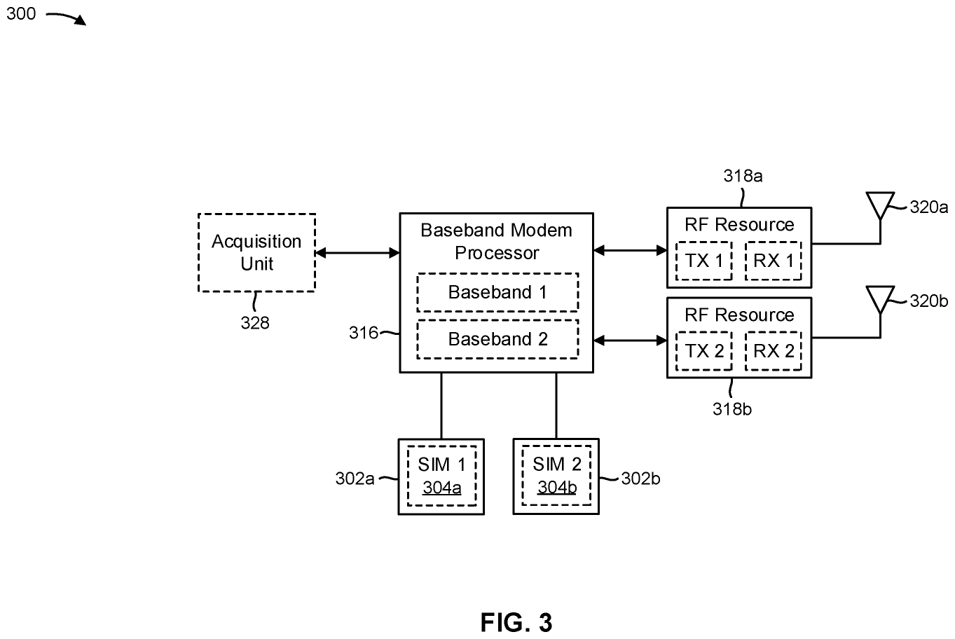

FIG. 3 is a diagram illustrating an example radio and baseband architecture 300 in a UE having multiple SIMs, in accordance with the present disclosure. In some aspects, the radio and baseband architecture 300 shown in FIG. 3 represents one possible configuration for the UE 120 shown in FIGS. 1-2.

In some aspects, as shown in FIG. 3, a first SIM interface 302a may receive a first SIM (shown as SIM 1) 304a associated with a first subscription, and a second SIM interface 302b may receive a second SIM (shown as SIM 2) 304b associated with a second subscription. In some aspects, the first subscription and the second subscription may be for different wireless networks or for the same wireless network. In some aspects, the first subscription may be a dedicated data subscription (DDS) that can be used to transfer data over a packet-switched connection and/or enable voice and/or multimedia message service (MMS) communication over a circuit-switched connection, and the second subscription may be a non-dedicated data subscription (nDDS) that can be used for voice and/or MMS communication only.

As used herein, the terms “SIM,” “SIM card,” “subscriber identity module,” “universal SIM,” “USIM,” and variants thereof may interchangeably refer to a memory that may be an integrated circuit or embedded into a removable card or soldered into a device to store an International Mobile Subscriber Identity (IMSI), a related key, and/or other information used to identify and/or authenticate a UE on a wireless network and enable a communication service with the wireless network. Because the information stored in a SIM enables the UE to establish a communication link for a particular communication service with a particular network, the term “SIM” may also be used herein as a shorthand reference to the communication service associated with and enabled by the information stored in a particular SIM, as the SIM and the communication network (as well as the services and subscriptions supported by that network) generally correlate to one another.

In some aspects, the first SIM 304a and/or the second SIM 304b may be a Universal Integrated Circuit Card (UICC) configured with SIM and/or universal SIM (USIM) applications, which may enable access to a wireless network. The UICC may also provide storage for a phone book and/or other suitable applications. Additionally, or alternatively, the first SIM 304a and/or the second SIM 304b may be an embedded UICC (eUICC), an embedded SIM (eSIM), and/or a removable user identity module (R-UIM), among other examples. The first SIM 304a and/or the second SIM 304b may include a processor, a read-only memory (ROM), a random access memory (RAM), electrically erasable programmable ROM (EEPROM), and/or input/output (I/O) circuits. In some aspects, an Integrated Circuit Card Identity (ICCID) SIM serial number may be printed on the SIM card for identification. However, a SIM may be implemented in a portion of memory of the UE, and thus need not be a separate or removable circuit, chip, or card. A SIM used in various aspects described herein may store user account information, an IMSI, a set of SIM application toolkit (SAT) commands, and other network provisioning information, as well as provide storage space for a phone book database that contains user contacts. As part of the network provisioning information, a SIM may store home identifiers (e.g., a System Identification Number (SID)/Network Identification Number (NID) pair, and/or a Home PLMN (HPLMN) code, among other examples) to indicate the SIM card network operator provider.

In some aspects, each SIM (e.g., the first SIM 304a and the second SIM 304b) may be associated with a baseband radio frequency (RF) resource chain, which may include a baseband modem processor 316 that may perform baseband and/or modem functions for communications on at least one SIM. Furthermore, in some aspects, the baseband RF resource chain may include one or more amplifiers and radios, referred to generally herein as RF resources 318a, 318b (e.g., first RF resource 318a and second RF resource 318b). In some aspects, the baseband RF resource chains may share the baseband modem processor 316 (e.g., where the baseband modem processor 316 performs baseband and/or modem functions for all SIMs on the UE). In other embodiments, each baseband RF resource chain may include physically or logically separate baseband processors (e.g., baseband 1 and baseband 2).

In some aspects, the RF resources 318a, 318b may each be transceivers that perform transmit and/or receive functions for the associated SIMs 304a, 304b. The RF resources 318a, 318b may include separate transmit and receive circuitry, or the RF resources 318a, 318b may include a transceiver that combines transmitter and receiver functions. The RF resources 318a, 318b may each be coupled to one or more wireless antennas (e.g., in FIG. 3, the first RF resource 318a is coupled to a first wireless antenna 320a and the second RF resource 318b is coupled to a second wireless antenna 320b). The RF resources 318a, 318b may also be coupled to the baseband modem processor 316. In some aspects, the first RF resource 318a and any associated components may be associated with the first subscription enabled by the first SIM 304a. For example, the RF resource 318a may be configured to transmit and/or receive data via a first wireless connection. In some aspects, the second RF resource 318b may be associated with the second subscription enabled by the second SIM 304b. For example, the RF resource 318b may be configured to transmit and/or receive data via a second wireless connection. Additionally, or alternatively, in some aspects, the first SIM 302a and the second SIM 304b may share one or more components of the RF resources 318a, 318b (e.g., one or more power amplifiers). Furthermore, in some aspects, the UE implementing the radio and baseband architecture 300 may include additional SIM cards, SIM interfaces, RF resources associated with the additional SIM cards, and additional antennae for connecting to additional mobile networks.

In some aspects, the radio and baseband architecture 300 may include an acquisition unit 328 configured to manage and/or schedule utilization of RF resources 318a, 318b for acquisition processes. For example, the acquisition unit 328 can be configured to perform acquisition processes for the first subscription and the second subscription. In some aspects, acquisition unit 328 may include (or couple to) at least one of a radio resource control (RRC) layer, a radio resource management (RRM) layer, a radio link control (RLC) layer, a medium access control (MAC) layer, and/or a physical layer. Hardware and/or software for one or more functions described herein may be incorporated in the radio and baseband architecture 300 during manufacturing, for example, as part of the original equipment manufacturer (OEM) configuration of a UE implementing the radio and baseband architecture 300. In some aspects, the hardware and/or software may be added to the radio and baseband architecture 300 post-manufacture, such as by installing one or more software applications onto the UE implementing the radio and baseband architecture 300.

As indicated above, FIG. 3 is provided as an example. Other examples may differ from what is described with regard to FIG. 3.

FIG. 4 is a diagram illustrating an example 400 associated with a voice callback feature for a multi-SIM device, in accordance with the present disclosure. As shown in FIG. 4, a UE 120 may be a multiple SIM (multi-SIM) UE that includes multiple SIMs (two or more SIMs), shown in FIG. 4 as a first SIM 405a and a second SIM 405b. The first SIM 405a may be associated with a first subscription (shown as SUB 1), which may be a DDS, and the second SIM 405b may be associated with a second subscription (shown as SUB 2), which may be an nDDS. A subscription may be a subscription with a network operator (e.g., a mobile network operator (MNO)) that enables the UE 120 to access a wireless network (e.g., a radio access network (RAN) and/or a core network associated with the network operator).

A SIM 405 may be a removable SIM (e.g., a SIM card) or an eSIM. A SIM 405 may include an integrated circuit that securely stores an IMSI and a security key, which are used to identify and authenticate a corresponding subscription associated with the SIM 405. In some cases, a SIM 405 may store a list of services that the UE 120 has permission to access using a subscription associated with the SIM 405, such as a data service, a voice service, and/or an MMS, among other examples.

As further shown in FIG. 4, the UE 120 may communicate (for example, in a connected mode, an idle mode, or an inactive mode) with a first base station 410a via a first cell 415a (shown as Cell 1) using the first SIM 405a. In this case, a first subscription (SUB 1) of the UE 120 may be used to access the first cell 415a (for example, using a first IMSI for UE identification, using a first security key for UE authentication, using a first list of services that the UE 120 is permitted to access using the first subscription, or by counting data or voice usage on the first cell against the first subscription, among other examples). Similarly, the UE 120 may communicate (for example, in a connected mode, an idle mode, or an inactive mode) with a second base station 410b via a second cell 415b (shown as Cell 2) using the second SIM 405b. In this case, a second subscription (SUB 2) of the UE 120 may be used to access the second cell 415b (for example, using a second IMSI for UE identification, using a second security key for UE authentication, using a second list of services that the UE 120 is permitted to access using the second subscription, or by counting data or voice usage on the second cell against the second subscription, among other examples).

The first base station 410a and/or the second base station 410b may include one or more of the base stations 110 described above in connection with FIG. 1. Although the first cell 415a and the second cell 415b are shown as being provided by different base stations, in some aspects, the first cell 415 and the second cell 415b may be provided by the same base station. Thus, in some aspects, the first base station 410a and the second base station 410b may be integrated into a single base station.

In some cases, the UE 120 may be capable of operating in a multi-SIM multiple standby (MSMS) mode, such as a dual-receive dual-SIM-dual-standby (DR-DSDS) mode (e.g., when the UE 120 is associated with two subscriptions, such as a DDS that can be used for data communication and voice and/or MMS communication and a non-dedicated nDDS that can be used only for voice and/or MMS communication). Additionally, or alternatively, the UE 120 may be capable of operating in a multi-SIM multiple active (MSMA) mode, such as a dual-SIM-dual-active (DSDA) mode (e.g., when the UE 120 is associated with two subscriptions, such as a DDS and an nDDS).

In the DSDA mode, the UE 120 may generally support concurrent active communication using both SIMs of the UE 120. Accordingly, when the UE 120 is operating in the DSDA mode, the UE 120 may be capable of communicating using the first SIM 405a (and the first subscription) at the same time as communicating using the second SIM 405b (and the second subscription). For example, when the UE 120 is engaged in an active session (e.g., a voice call or a data session, such as online gaming, Internet browsing, stock trading, or an over-the-top (OTT) service) using the first SIM 405a, the UE 120 is capable of receiving a notification of a voice call using the second SIM 405b without interrupting communications that use the first SIM 405a, and without tuning or switching away from the first cell 415a to tune to the second cell 415b.

In the DR-DSDS mode, the UE 120 may generally lack support for concurrent active data communication using both SIMs of the UE 120. Accordingly, when the UE 120 is operating in the DR-DSDS mode, the UE 120 may be incapable of communicating data using the first SIM 405a (and the first subscription) at the same time as communicating data using the second SIM 405b (and the second subscription). However, a UE 120 in the DR-DSDS mode may be capable of switching between two separate mobile network services, may include hardware for maintaining multiple connections (for example, one connection per SIM) in a standby state, may include hardware (for example, multiple transceivers) for maintaining multiple network connections at the same time, and/or may support concurrency of data communication and voice communication on different SIMs 405, among other examples. However, a UE 120 in the DR-DSDS mode may be capable of transmitting and/or receiving data on only one connection at a time because one or more RF resources are shared between the multiple subscriptions. For example, a UE 120 in the DR-DSDS mode may be associated with multiple subscriptions but may include only a single transceiver shared by the multiple subscriptions or a single transmit chain shared by the multiple subscriptions, among other examples.

In some examples, the UE 120 may be a hybrid DR-DSDS and DSDA device that is capable of operating in the DSDA mode for a first set of RAT combinations and incapable of operating in the DSDA mode for a second set of RAT combinations. In other words, the UE 120 may support operating in either the DR-DSDS mode or the DSDA mode for the first set of RAT combinations and may support operating in only the DR-DSDS mode for the second set of RAT combinations. In some aspects, the inability to support to support the DSDA mode for the second set of RAT combinations may be based on RF coexistence issues, where concurrent active communication using the second set of RAT combinations may cause severe performance degradation (e.g., transmissions via one SIM may severely degrade reception performance on the other SIM). For example, in some aspects, the UE 120 may be capable of operating in the DSDA mode for NR+NR, where the first cell 415a (as well as the first SIM 405a and the first subscription) uses an NR RAT and the second cell 415b (as well as the second SIM 405b and the second subscription) also uses the NR RAT. However, the UE 120 may not be capable of operating in the DSDA mode for NR+LTE, where one of the first cell 415a (as well as the first SIM 405a and the first subscription) uses an NR RAT and the second cell 415b (as well as the second SIM 405b and the second subscription) uses an LTE RAT (or vice versa). In some aspects, the UE 120 may not be capable of operating in the DSDA mode for the second combination of RATs (e.g., NR+LTE), but be capable of operating in the DR-DSDS mode for the second combination of RATs. The hybrid DR-DSDS and DSDA design may reduce UE design costs compared to enabling the UE 120 to operate using the DSDA mode for all RAT combinations (e.g., by avoiding a need to mitigate RF coexistence issues).

As shown in FIG. 4, and by reference number 420, the UE 120 may be engaged in an ongoing data session on the first SIM 405a, which may be associated with a DDS that supports concurrent data and voice/MMS communication. In some aspects, as described herein, the UE 120 may be engaged in the ongoing data session (e.g., an Internet browsing session, online gaming, and/or video streaming, among other examples) while operating in the DR-DSDS mode. For example, when operating in the DR-DSDS mode, the UE 120 may be engaged in the ongoing data session using a first receive chain and a first transmit chain of the UE 120. In some aspects, the UE 120 may also use a second transmit chain in order to support the ongoing data session. For example, in some aspects, the UE 120 may be configured for uplink carrier aggregation and/or MIMO operation to support transmissions associated with the ongoing data session on the first SIM. In some aspects, during operation in the DR-DSDS mode, the UE 120 may use a second receive chain to check a paging channel associated with the second SIM 405b, which may be associated with an nDDS that supports only voice communication and/or MMS communication.

As further shown in FIG. 4, and by reference number 425, the UE 120 may detect (e.g., on the paging channel associated with the second SIM 405b) an indication related to an incoming voice call on the second SIM 405b using the second receive chain. In this case, because the UE 120 is operating in the DR-DSDS mode, default legacy behavior may be for the UE 120 to suspend or interrupt the ongoing data session on the first SIM 405a to accept the incoming voice call on the second SIM 405b. In other words, because the UE 120 can maintain only a single call associated with a single SIM and cannot concurrently maintain different calls associated with different SIMs when operating in the DR-DSDS mode, receiving an incoming voice call on the second SIM 405b associated with an nDDS will preempt any ongoing data session on the first SIM 405a associated with a DDS. However, in some cases, the UE 120 (or a user of the UE 120) may prefer to preserve the ongoing data session on the first SIM 405a. Accordingly, some aspects described herein may enable the UE 120 to preserve the ongoing data session on the first SIM 405a when an incoming voice call is received on the second SIM 405b while the UE 120 is operating in the DR-DSDS mode. Furthermore, in some aspects, the UE 120 may respond to a caller associated with the incoming voice call via the first SIM 405a, whereby the user of the UE 120 may preserve the ongoing data session and concurrently initiate an outbound communication to establish a conversation with the caller associated with the incoming voice call.

For example, as shown by reference number 530, the UE 120 may determine, during the ongoing data session on the first SIM 405a, a caller identifier associated with the incoming voice call on the second SIM 405b. For example, when the UE 120 receives the incoming voice call on the second SIM 405b while operating in the DR-DSDS mode, the UE 120 may briefly interrupt the ongoing data session on the first SIM 405a and activate a protocol stack associated with the second SIM 405b to setup the incoming voice call on the second SIM 405b in a manner where the first SIM 405a and the second SIM 405b are operating in a time sharing manner (e.g., either the first SIM 405a or the second SIM 405b may be active at any one time instant, but the first SIM 405a and the second SIM 405b are not both active at the same time). The UE 120 may then receive, via the second SIM 405b, the caller identifier associated with the incoming voice call, which may include a telephone number associated with the caller, a contact name associated with the caller, an email address associated with the caller, and/or any other suitable identifier that may be used to address an endpoint associated with a voice call. The UE 120 may store the caller identifier associated with the incoming voice call (e.g., in a missed call log or other suitable memory of the UE 120), and the UE 120 may then drop the incoming voice call on the second SIM 405b and continue with the ongoing data session on the first SIM 405a. Alternatively, in some aspects, the UE 120 may determine the caller identifier associated with the incoming voice call by temporarily transitioning to the DSDA mode, which may allow the first SIM 405a and the second SIM 405b to be active concurrently. In such cases, the UE 120 may transition to the DSDA mode for a duration that is sufficient to extract or otherwise obtain the caller identifier, and the UE 120 may then drop the incoming voice call and return to the DR-DSDS mode. In cases where the UE 120 briefly transitions to the DSDA mode, and to the extent that the ongoing data session on the first SIM 405a may potentially experience performance degradation due to activity on the second SIM 405b, the degraded performance may be limited to the brief duration that the UE 120 is operating in the DSDA mode. Alternatively, in some aspects, the UE 120 may determine the caller identifier associated with the incoming voice call on the second SIM 405b without having to interrupt or otherwise disrupt the ongoing data session on the first SIM 405a where the UE 120 is associated with a multi-SIM design that allows concurrency of data communication and voice communication on different SIMs.

As further shown in FIG. 4, and by reference number 435, the UE 120 may initiate, via the first SIM 405a associated with the ongoing data session, an outbound communication to the caller identifier extracted from the incoming voice call (e.g., to another UE associated with the caller identifier) in concurrency with the ongoing data session on the first SIM 405a. For example, in some aspects, the UE 120 may support one or more options related to the outbound communication to be initiated via the first SIM 405 associated with the DDS that supports concurrent data and voice/MMS communication, and the UE 120 may generate a user prompt that indicates the available option(s) to respond to the incoming voice call received on the second SIM 405b, which may include an option not to respond to the incoming voice call received on the second SIM 405b. For example, the user prompt may include a graphical user interface, a voice assistant message, haptic feedback, and/or any other suitable prompt that indicates the available option(s) to respond (or not respond) to the incoming voice call. Accordingly, in some aspects, the UE 120 may be configured to receive a user selection of a response option presented via the user prompt, and may configure the outbound communication to be initiated via the first SIM 405a based on the user selected response option. Alternatively, in cases where the user selects the option not to respond to the incoming voice call received on the second SIM 405b, the UE 120 may reject the incoming voice call without initiating any outbound communication via the first SIM 405a.

For example, in some aspects, the one or more response options presented via the user prompt may include an option to initiate a voice callback via the first SIM 405b, in which case the UE 120 may initiate a mobile-originated voice call to the caller identifier associated with the incoming voice call on the first SIM 405a in concurrency with the ongoing data session on the first SIM 405a. In another example, the one or more response options may include sending a message (e.g., a Short Message Service (SMS) message, an MMS, a text message, a voice message, a video message, and/or an instant message, among other examples) that indicates an unavailable status to the caller identifier associated with the incoming voice call via the first SIM 405a. For example, in some aspects, the message may include text such as “I'm busy, I will call you back later” or other suitable language that is sent to the caller identifier to indicate that the user of the UE 120 is aware of the incoming voice call but not presently available to take the voice call (e.g., because of the ongoing data session). Additionally, or alternatively, the message sent to the caller identifier may include language to request that the caller attempt a callback via a phone number or other address information associated with the first 405a (e.g., the UE 120 may be incapable of taking the voice call on the second SIM 405b while the data session on the first SIM 405a is ongoing in the DR-DSDS mode, but the DDS of the first SIM 405a may support a concurrent data session and voice call on the first SIM 405a).

In some aspects, the form of (e.g., the specific language used in) the message that is sent to the caller identifier can be preconfigured at the UE 120, or the user of the UE 120 may select among different options for the message and/or specify a custom message. Furthermore, in some aspects, the response option that is initiated by the UE 120 via the first SIM 405a (e.g., initiating a voice callback, sending a message indicating an unavailable status, and/or sending a message requesting a callback on the first SIM 405a, among other examples) may be selected automatically based on one or more settings that are configured at the UE 120. For example, the one or more settings may be programmatically configured at the UE 120, configured by the user of the UE 120, and/or defined on an application-specific basis (e.g., initiating a voice callback when the ongoing data session involves applications with a low priority or sending a message indicating an unavailable status when the ongoing data session involves applications with a high priority), among other examples.

In some aspects, the UE 120 may determine whether to reject the incoming voice call on the second SIM 405b based on one or more metrics that relate to communication quality, cost, and/or performance associated with the first SIM 405a and/or the second SIM 405b. For example, in some aspects, the UE 120 may evaluate the one or more metrics to determine whether a brief interruption to the ongoing data session on the first SIM 405a is the optimal action to protect performance and/or user experience for the ongoing data session on the first SIM 405a. In such cases, where the UE 120 determines that accepting the incoming voice call on the second SIM 405b may cause suboptimal performance (e.g., degradation to the ongoing data session on the first SIM 405a), the UE 120 may decide to reject the incoming voice call and may initiate the outbound communication to the caller identifier on the first SIM 405a and/or present the user prompt with the one or more response options. For example, in some aspects, the UE 120 may evaluate metrics such as the number of RF bands each SIM 405 is camped on, the RF conditions of each SIM 405, the number of antennas allocated to each SIM 405, supported codec types on wireless networks associated with each SIM 405, costs associated with data and/or voice communication on the respective SIMs, and/or a priority associated with the ongoing data session, among other examples. Accordingly, the UE 120 may determine whether to accept or reject the incoming voice call based on the one or more metrics (e.g., to optimally protect performance and/or user experience of the ongoing data session and/or the incoming voice call).

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with a voice callback feature for a multi-SIM device.

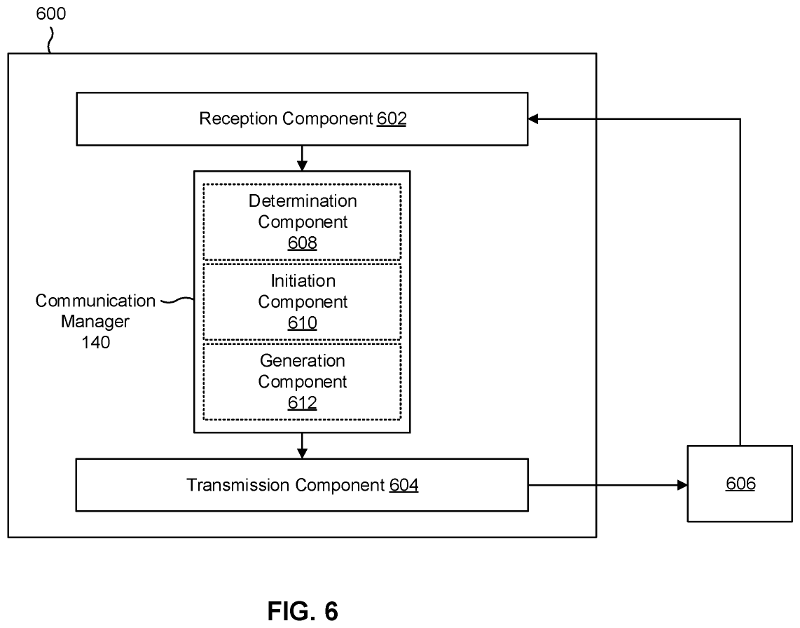

As shown in FIG. 5, in some aspects, process 500 may include receiving, during an ongoing data session on a first SIM, an incoming voice call on a second SIM (block 510). For example, the UE (e.g., using communication manager 140 and/or reception component 602, depicted in FIG. 6) may receive, during an ongoing data session on a first SIM, an incoming voice call on a second SIM, as described above.

As further shown in FIG. 5, in some aspects, process 500 may include determining, during the ongoing data session on the first SIM, a caller identifier associated with the incoming voice call on the second SIM (block 520). For example, the UE (e.g., using communication manager 140 and/or determination component 608, depicted in FIG. 6) may determine, during the ongoing data session on the first SIM, a caller identifier associated with the incoming voice call on the second SIM, as described above.

As further shown in FIG. 5, in some aspects, process 500 may include initiating, on the first SIM, a communication to the caller identifier associated with the incoming voice call in concurrency with the ongoing data session (block 530). For example, the UE (e.g., using communication manager 140 and/or initiation component 610, depicted in FIG. 6) may initiate, on the first SIM, a communication to the caller identifier associated with the incoming voice call in concurrency with the ongoing data session, as described above.

Process 500 may include additional aspects, such as any single aspect or any combination of aspects described below and/or in connection with one or more other processes described elsewhere herein.

In a first aspect, initiating the communication includes originating, on the first SIM, a voice call to the caller identifier associated with the incoming voice call.

In a second aspect, alone or in combination with the first aspect, initiating the communication includes sending, via the first SIM, a message that indicates an unavailable status to the caller identifier associated with the incoming voice call.

In a third aspect, alone or in combination with one or more of the first and second aspects, initiating the communication includes sending, via the first SIM, a message to the caller identifier associated with the incoming voice call to request a callback to a phone number associated with the first SIM.

In a fourth aspect, alone or in combination with one or more of the first through third aspects, the first SIM is associated with a DDS and the second SIM is associated with an nDDS.

In a fifth aspect, alone or in combination with one or more of the first through fourth aspects, the incoming voice call is received while the UE is operating in a DR-DSDS mode.

In a sixth aspect, alone or in combination with one or more of the first through fifth aspects, determining the caller identifier associated with the incoming voice call includes transitioning from the DR-DSDS mode to a DSDA mode, determining the caller identifier associated with the incoming voice call while operating in the DSDA mode, and returning to the DR-DSDS mode based at least in part on determining the caller identifier.

In a seventh aspect, alone or in combination with one or more of the first through sixth aspects, the caller identifier is determined while the UE is operating in the DR-DSDS mode.

In an eighth aspect, alone or in combination with one or more of the first through seventh aspects, process 500 includes generating a user prompt that indicates one or more options to respond or not respond to the incoming voice call received on the second SIM, wherein the communication is initiated to the caller identifier associated with the incoming voice call based at least in part on a user selection of an option included among the one or more options to respond to the incoming voice call.

In a ninth aspect, alone or in combination with one or more of the first through eighth aspects, the communication is initiated to the caller identifier associated with the incoming voice call based at least in part on one or more settings configured at the UE.

In a tenth aspect, alone or in combination with one or more of the first through ninth aspects, the communication is initiated to the caller identifier associated with the incoming voice call based at least in part on one or more metrics associated with one or more of the first SIM or the second SIM.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include one or more of a determination component 608, an initiation component 610, or a generation component 612, among other examples.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The reception component 602 may receive, during an ongoing data session on a first SIM, an incoming voice call on a second SIM. The determination component 608 may determine, during the ongoing data session on the first SIM, a caller identifier associated with the incoming voice call on the second SIM. The initiation component 610 may initiate, on the first SIM, a communication to the caller identifier associated with the incoming voice call in concurrency with the ongoing data session.

The generation component 612 may generate a user prompt that indicates one or more options to respond or not respond to the incoming voice call received on the second SIM, wherein the communication is initiated to the caller identifier associated with the incoming voice call based at least in part on a user selection of an option included among the one or more options to respond to the incoming voice call.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:
Aspect 1: A method of wireless communication performed by a UE, comprising: receiving, during an ongoing data session on a first SIM, an incoming voice call on a second SIM; determining, during the ongoing data session on the first SIM, a caller identifier associated with the incoming voice call on the second SIM; and initiating, on the first SIM, a communication to the caller identifier associated with the incoming voice call in concurrency with the ongoing data session.
Aspect 2: The method of Aspect 1, wherein initiating the communication includes originating, on the first SIM, a voice call to the caller identifier associated with the incoming voice call.
Aspect 3: The method of any of Aspects 1-2, wherein initiating the communication includes sending, via the first SIM, a message that indicates an unavailable status to the caller identifier associated with the incoming voice call.
Aspect 4: The method of any of Aspects 1-3, wherein initiating the communication includes sending, via the first SIM, a message to the caller identifier associated with the incoming voice call to request a callback to a phone number associated with the first SIM.
Aspect 5: The method of any of Aspects 1-4, wherein the first SIM is associated with a DDS and the second SIM is associated with an nDDS.
Aspect 6: The method of any of Aspects 1-5, wherein the incoming voice call is received while the UE is operating in a DR-DSDS mode.
Aspect 7: The method of Aspect 6, wherein determining the caller identifier associated with the incoming voice call includes: transitioning from the DR-DSDS mode to a DSDA mode; determining the caller identifier associated with the incoming voice call while operating in the DSDA mode; and returning to the DR-DSDS mode based at least in part on determining the caller identifier.
Aspect 8: The method of any of Aspects 6-7, wherein the caller identifier is determined while the UE is operating in the DR-DSDS mode.
Aspect 9: The method of any of Aspects 1-8, further comprising: generating a user prompt that indicates one or more options to respond or not respond to the incoming voice call received on the second SIM, wherein the communication is initiated to the caller identifier associated with the incoming voice call based at least in part on a user selection of an option included among the one or more options to respond to the incoming voice call.
Aspect 10: The method of any of Aspects 1-9, wherein the communication is initiated to the caller identifier associated with the incoming voice call based at least in part on one or more settings configured at the UE.
Aspect 11: The method of any of Aspects 1-10, wherein the communication is initiated to the caller identifier associated with the incoming voice call based at least in part on one or more metrics associated with one or more of the first SIM or the second SIM.
Aspect 12: An apparatus for wireless communication at a device, comprising a processor; memory coupled with the processor; and instructions stored in the memory and executable by the processor to cause the apparatus to perform the method of one or more of Aspects 1-11.
Aspect 13: A device for wireless communication, comprising a memory and one or more processors coupled to the memory, the one or more processors configured to perform the method of one or more of Aspects 1-11.
Aspect 14: An apparatus for wireless communication, comprising at least one means for performing the method of one or more of Aspects 1-11.
Aspect 15: A non-transitory computer-readable medium storing code for wireless communication, the code comprising instructions executable by a processor to perform the method of one or more of Aspects 1-11.
Aspect 16: A non-transitory computer-readable medium storing a set of instructions for wireless communication, the set of instructions comprising one or more instructions that, when executed by one or more processors of a device, cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, during an ongoing data session on a first subscriber identity module (SIM), an incoming voice call on a second SIM;
determining, during the ongoing data session on the first SIM, a caller identifier associated with the incoming voice call on the second SIM; and
initiating, on the first SIM, a communication to the caller identifier associated with the incoming voice call in concurrency with the ongoing data session.

2. The method of claim 1, wherein initiating the communication includes originating, on the first SIM, a voice call to the caller identifier associated with the incoming voice call.

3. The method of claim 1, wherein initiating the communication includes sending, via the first SIM, a message that indicates an unavailable status to the caller identifier associated with the incoming voice call.

4. The method of claim 1, wherein initiating the communication includes sending, via the first SIM, a message to the caller identifier associated with the incoming voice call to request a callback to a phone number associated with the first SIM.

5. The method of claim 1, wherein the first SIM is associated with a dedicated data subscription and the second SIM is associated with a non-dedicated data subscription.

6. The method of claim 1, wherein the incoming voice call is received while the UE is operating in a dual-receive dual-SIM-dual-standby (DR-DSDS) mode.

7. The method of claim 6, wherein determining the caller identifier associated with the incoming voice call includes:
transitioning from the DR-DSDS mode to a dual-SIM-dual-active (DSDA) mode;
determining the caller identifier associated with the incoming voice call while operating in the DSDA mode; and
returning to the DR-DSDS mode based at least in part on determining the caller identifier.

8. The method of claim 6, wherein the caller identifier is determined while the UE is operating in the DR-DSDS mode.

9. The method of claim 1, further comprising:
generating a user prompt that indicates one or more options to respond or not respond to the incoming voice call received on the second SIM, wherein the communication is initiated to the caller identifier associated with the incoming voice call based at least in part on a user selection of an option included among the one or more options to respond to the incoming voice call.

10. The method of claim 1, wherein the communication is initiated to the caller identifier associated with the incoming voice call based at least in part on one or more settings configured at the UE.

11. The method of claim 1, wherein the communication is initiated to the caller identifier associated with the incoming voice call based at least in part on one or more metrics associated with one or more of the first SIM or the second SIM.

12. A user equipment (UE) for wireless communication, comprising:
a memory; and
one or more processors, coupled to the memory, configured to:
receive, during an ongoing data session on a first subscriber identity module (SIM), an incoming voice call on a second SIM;
determine, during the ongoing data session on the first SIM, a caller identifier associated with the incoming voice call on the second SIM; and
initiate, on the first SIM, a communication to the caller identifier associated with the incoming voice call in concurrency with the ongoing data session.

13. The UE of claim 12, wherein the one or more processors, to initiate the communication, are configured to originate, on the first SIM, a voice call to the caller identifier associated with the incoming voice call.

14. The UE of claim 12, wherein the one or more processors, to initiate the communication, are configured to send, via the first SIM, a message that indicates an unavailable status to the caller identifier associated with the incoming voice call.

15. The UE of claim 12, wherein the one or more processors, to initiate the communication, are configured to send, via the first SIM, a message to the caller identifier associated with the incoming voice call to request a callback to a phone number associated with the first SIM.

16. The UE of claim 12, wherein the first SIM is associated with a dedicated data subscription and the second SIM is associated with a non-dedicated data subscription.

17. The UE of claim 12, wherein the incoming voice call is received while the UE is operating in a dual-receive dual-SIM-dual-standby (DR-DSDS) mode.

18. The UE of claim 17, wherein the one or more processors, to determine the caller identifier associated with the incoming voice call, are configured to:
transition from the DR-DSDS mode to a dual-SIM-dual-active (DSDA) mode;
determine the caller identifier associated with the incoming voice call while operating in the DSDA mode; and
return to the DR-DSDS mode based at least in part on determining the caller identifier.

19. The UE of claim 17, wherein the caller identifier is determined while the UE is operating in the DR-DSDS mode.

20. The UE of claim 12, wherein the one or more processors are further configured to:
generate a user prompt that indicates one or more options to respond or not respond to the incoming voice call received on the second SIM, wherein the communication is initiated to the caller identifier associated with the incoming voice call based at least in part on a user selection of an option included among the one or more options to respond to the incoming voice call.

21. The UE of claim 12, wherein the communication is initiated to the caller identifier associated with the incoming voice call based at least in part on one or more settings configured at the UE.

22. The UE of claim 12, wherein the communication is initiated to the caller identifier associated with the incoming voice call based at least in part on one or more metrics associated with one or more of the first SIM or the second SIM.

23. A non-transitory computer-readable medium storing a set of instructions for wireless communication, the set of instructions comprising:
one or more instructions that, when executed by one or more processors of a user equipment (UE), cause the UE to:
receive, during an ongoing data session on a first subscriber identity module (SIM), an incoming voice call on a second SIM;
determine, during the ongoing data session on the first SIM, a caller identifier associated with the incoming voice call on the second SIM; and
initiate, on the first SIM, a communication to the caller identifier associated with the incoming voice call in concurrency with the ongoing data session.

24. The non-transitory computer-readable medium of claim 23, wherein the one or more instructions, that cause the UE to initiate the communication, cause the UE to originate, on the first SIM, a voice call to the caller identifier associated with the incoming voice call.

25. The non-transitory computer-readable medium of claim 23, wherein the one or more instructions, that cause the UE to initiate the communication, cause the UE to send, via the first SIM, a message that indicates an unavailable status to the caller identifier associated with the incoming voice call.

26. The non-transitory computer-readable medium of claim 23, wherein the one or more instructions, that cause the UE to initiate the communication, cause the UE to send, via the first SIM, a message to the caller identifier associated with the incoming voice call to request a callback to a phone number associated with the first SIM.

27. An apparatus for wireless communication, comprising:
means for receiving, during an ongoing data session on a first subscriber identity module (SIM), an incoming voice call on a second SIM;
means for determining, during the ongoing data session on the first SIM, a caller identifier associated with the incoming voice call on the second SIM; and
means for initiating, on the first SIM, a communication to the caller identifier associated with the incoming voice call in concurrency with the ongoing data session.

28. The apparatus of claim 27, wherein the means for initiating the communication includes means for originating, on the first SIM, a voice call to the caller identifier associated with the incoming voice call.

29. The apparatus of claim 27, wherein the means for initiating the communication includes means for sending, via the first SIM, a message that indicates an unavailable status to the caller identifier associated with the incoming voice call.

30. The apparatus of claim 27, wherein the means for initiating the communication includes means for sending, via the first SIM, a message to the caller identifier associated with the incoming voice call to request a callback to a phone number associated with the first SIM.
